(19) United States
(12) Patent Application Publication
(10) Pub. No.: US 2004/0091103 A1
(43) Pub. Date: May 13, 2004

(54) Method for data transmission

(76) Inventors: Tobias Martin, Rabenau (DE); Joerg Schwenk, Henfenfeld (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/343,614

(22) PCT Filed: Jul. 5, 2001
(86) PCT No.: PCT/EP01/07699

(30) Foreign Application Priority Data
Aug. 4, 2000 (DE) 100-38-068.9

(51) Int. Cl. H04K 1/00; H04L 9/00

(52) U.S. Cl. 380/28

(57) ABSTRACT

The invention relates to a method for transmitting data to a subset of users via a radio medium. The users are managed as leaves of a tree structure consisting of a root, knots and leaves. Keys are allocated to the knots and leaves of the tree structure. The users have the keys allocated to their leaf and the knots on the path between their leaf and the root. The data to be transmitted is encoded in such a way that it can be decoded respectively by the key to the knots which are closest to the root, the direct and indirect successors of said knots being only users belonging to the subset. The data can also be decoded by the keys which are allocated to the users belonging to the subset, the path between said users and the root containing no such knots.

### SPECIFICATION

The present invention relates to a method for transmitting data to a subset of users via a broadcast medium, the users being managed as leaves of a tree structure consisting of a root, nodes and leaves.

In modern information technology, it plays an increasingly important role to be able to distribute proprietary data to an authorized circle of users without in each case having to establish a point-to-point connection to the individual user. Examples of this include digital Pay-TV, data broadcasting, networks with broadcast function, data distribution via CD-ROM, and online databases which are subject to charge. This will be represented by the term “broadcast medium” used hereinafter.

In order to allow only authorized users access to the information, in all of the above mentioned media, the information is distributed in a form that is encrypted with a session key k. As a rule, a plurality of authorized persons have the possibility to decrypt this information. For this, they need the session key k which has to be distributed to them via the broadcast medium.

A solution to this problem is to give each user i a personal key ki in advance. Then, a cryptogram f(ki,k), in which session key k is encrypted with algorithm f and personal key ki, is computed for each authorized user i. Subsequently, all these cryptograms are sent via the broadcast medium

Upon receipt of such a cryptogram f(ki,k), an authorized user i can now use his/her personal key to decrypt the cryptogram, thus obtaining session key k. In place of a session key k, an arbitrary data set which is transmitted as a cryptogram can also be decrypted with personal key ki.

This procedure is efficient as long as only a small number of users are actually authorized since the number of cryptograms to be sent is proportional to the number of authorized users. In particular, it is extremely inefficient to withdraw authorization from a user because all other users must obtain a new cryptogram for that purpose.

A method which allows efficient withdrawal of authorizations is already described, inter alia, in German Patent DE 195 11 298.9. This method is based on the use of tree structures for managing the authorized users, the tree structure being modified upon withdrawal of authorization.

The object of the present invention is to propose a method for transmitting data to an authorized subset of users which makes it possible to temporarily withdraw the authorization with as little a transmission effort as possible.

This objective is achieved according to the present invention

in that keys are assigned to the nodes and leaves of the tree structure and in that the users have the keys which are assigned to their leaf and to the nodes on the path between their leaf and the root, and

in that the data to be transmitted is encrypted in such a manner

that the data to be transmitted can in each case be decrypted with the key of the nodes which are closest to the root and whose direct and indirect successors are only users belonging to the subset, and

that the data to be transmitted can also be decrypted with the keys that are assigned to the users who belong to the subset and who do not have any such nodes on their path to the root.

An advantageous embodiment of the present invention consist in that, when a user is removed from the subset, the respective path between the user who no longer belongs to the subset and the root is computed, and that the thus determined nodes are removed from the set of nodes whose keys can be used to decrypt the data.

Using the method according to the present invention, all types of data can be selectively transmitted to users via a broadcast medium. However, one advantageous application consists in that the data to be transmitted contains a session key that can be used to encrypt larger data volumes.

In most application cases, a distinction is made between authorized and unauthorized users, the authorized users constituting the subset. If, for example, a few Pay-TV users sign off for a short period of time due to vacation and no longer pay any subscription fees, the above described method can be used to transmit the session key for decryption of the Pay-TV program only to the remaining users.

However, also possible are applications where authorization is not decisive but the intention is only to send the subset of users a message which, in principle, could also be received by other users if they wanted to. The selective transmission of the data is hereinafter also referred to as “addressing”. A binary structure is applicable as the tree structure. However, the present invention can also be implemented using other tree structures, in general terms: p-ary tree.

Exemplary embodiments of the present invention are depicted in the drawing with reference to several Figures and will be explained in greater detail in the following description.

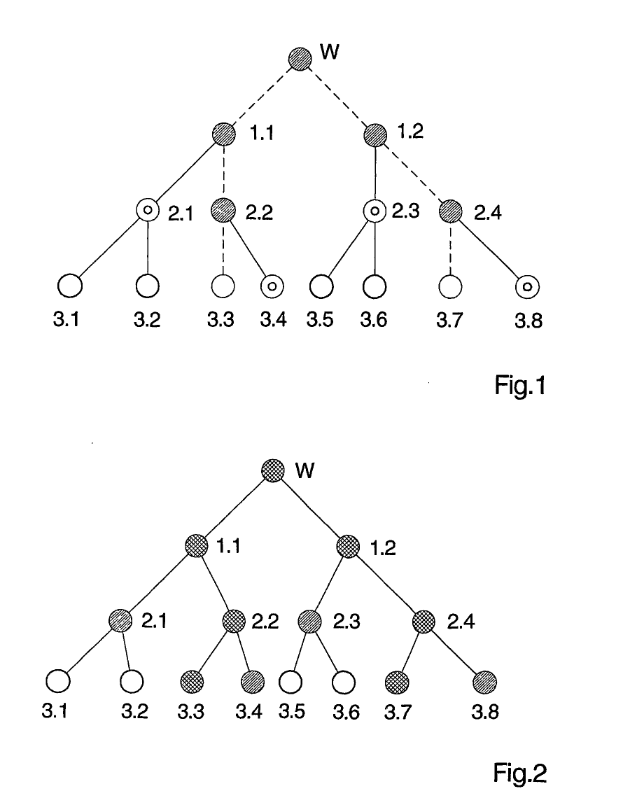

FIG. 1 shows a first case of addressing; and

FIG. 2 shows a second case of addressing.

In the Figures, identical parts are provided with the same reference symbols.

FIG. 1 depicts the method according to the present invention with reference to a tree structure which, in this example, is a binary tree that begins at root W and extends over three levels. The lowest level of the tree are the leaves, which are assigned to the users. Each node has assigned thereto a key. The user knows all the keys on the path from his/her leaf to the root. In the example shown, there exist eight users 3.1 through 3.8. The authorization was withdrawn from users 3 and 7, which is symbolized by circles 3.3 and 3.7 with a thin border. The path of users 3.3, 3.7 without authorization to root W is shown in broken lines and computed by the system operator. Nodes W, 1.1 and 2.2, on the one side, and W, 1.2 and 2.4, on the other side, which lie on the paths are marked. These points are classified as unusable. The highest possible nodes (the nodes lying at the highest level, respectively) 2.1, 2.3, 3.4 and 3.8 that are usable are marked with an inner ring in the representation. The data to be sent is encrypted in such a manner that it can be decrypted with the keys of these nodes.

In the following, m is used for the number of authorized users and n for the total number of users to illustrate the present invention. In the case of a binary tree, the total number of keys is then 2n−1 and the number of keys per user is log₂ n.

In the case that m n, each cryptogram contains a session key. All keys lying on the path of an excluded user 3.3, 3.7 are not used. In order to cover users 3.1, 3.2, 3.4, 3.5, 3.6; 3.8 who are not excluded, those keys of the remaining keys are used which are as close as possible to the root. The scheme is m-resilient because it uses none of the keys known by the m excluded users.

The number of keys used per transmission is <=m(log₂n-log₂ m). The reasons for this are explained below with reference to FIG. 2. In FIG. 2, the prohibited keys are crosshatched while the transmitted keys are single-hatched. In the worst case, the m excluded users 3.3, 3.7 are well-distributed within the tree. In this case, the overall tree is distributed into m subtrees at level log₂ m, which is indicated in FIG. 2 by the broken lines in level 1. In each of these subtrees, there is an excluded user. They have the height log₂ n-log₂ m. To address the users who are not excluded in each subtree, exactly one key is required for each level of the subtree, i.e., a total of log₂ n-log₂ m keys in each subtree.

What is claimed is:

1. A method for transmitting data to a subset of users via a broadcast medium, the users being managed as leaves of a tree structure consisting of a root, nodes and leaves, wherein
keys are assigned to the nodes and leaves of the tree structure and the users have the keys which are assigned to their leaf and to the nodes on the path between their leaf and the root, and the data to be transmitted is encrypted in such a manner
that the data to be transmitted can in each case be decrypted with the key of the nodes which are closest to the root and whose direct and indirect successors are only users belonging to the subset, and
that the data to be transmitted can also be decrypted with the keys that are assigned to the users who belong to the subset and who do not have any such nodes on their path to the root.

2. The method as recited in claim 1,
wherein when a user is removed fron the subset, the respective path between the user who no longer belongs to the subset and the root is computed; and
the thus determined nodes are removed from the set of nodes whose keys can be used to decrypt the data.

3. The method as recited in one of the claim 1 or 2,
wherein the data to be transmitted contains a session key that can be used to encrypt larger data volumes.
